(19) United States
(12) Patent Application Publication
(10) Pub. No.: US 2026/0234397 A1
(43) Pub. Date: Aug. 13, 2026

(54) REINFORCED POLYURETHANE RIGID FOAM MATERIAL AND PREPARATION METHOD THEREFOR

(71) Applicant: Jiangsu Yoke Technology Co., Ltd., Wuxi (CN)

(72) Inventors: Heng Cao, Wuxi (CN); Qi Shen, Wuxi (CN); Hongfei Zhu, Wuxi (CN); Jinhe Fan, Wuxi (CN); Huabing Wu, Wuxi (CN); Jianqing Ma, Wuxi (CN); Jian Sun, Wuxi (CN)

(21) Appl. No.: 19/452,167

(22) Filed: Jan. 16, 2026

Related U.S. Application Data
(63) Continuation of application No. PCT/CN2024/096285, filed on May 30, 2024.

(30) Foreign Application Priority Data
May 9, 2024 (CN) 202410568895.2

(51) Int. Cl. C08L 71/08; C08J 9/228; C08K 5/29; C08K 7/14; C08L 75/04

(52) U.S. Cl. CPC C08L 71/08; C08J 9/228; C08K 5/29; C08K 7/14; C08L 75/04

(57) ABSTRACT

A reinforced polyurethane rigid foam material and a preparation method therefor are provided. The reinforced polyurethane rigid foam material comprises, in parts by weight: 5-10 parts of glass fiber yarn, 40-60 parts of aromatic polyether polyol, 30-50 parts of aromatic polyester polyol, 30-50 parts of toluene diisocyanate, 40-60 parts of polymethylene polyphenyl polyisocyanate, 5-10 parts of a flame retardant, 5-15 parts of a foaming agent, 1-5 parts of a catalyst and 1-5 parts of a surfactant.

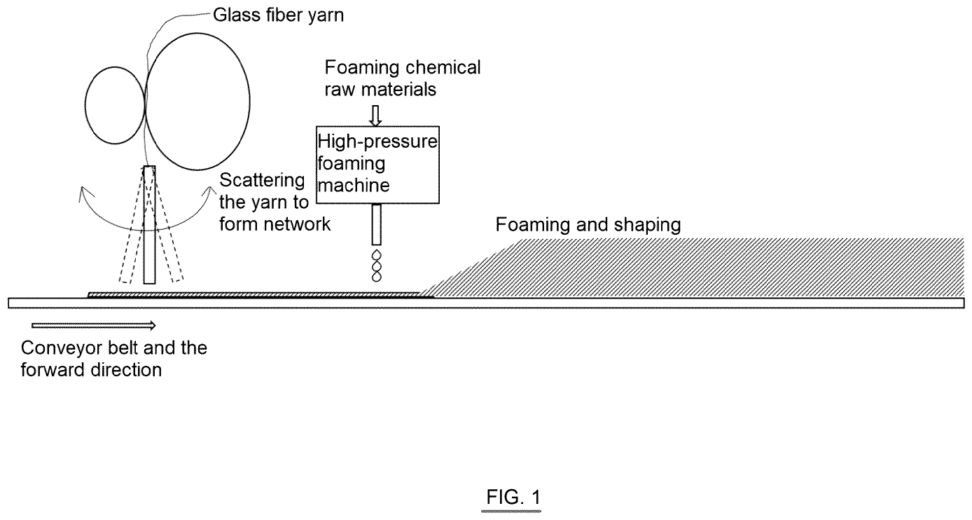

### CROSS REFERENCE TO RELATED APPLICATIONS

The present application is a continuation application of international application PCT/CN2024/096285 filed on May 30, 2024, and entitled “REINFORCED POLYURETHANE RIGID FOAM MATERIAL AND PREPARATION METHOD THEREFOR”, which international application claims the priority to Chinese patent application CN202410568895.2 filed with Chinese Patent Office on May 9, 2024, contents of which are incorporated herein by reference in their entirety.

### TECHNICAL FIELD

The present disclosure relates to the technical field of high polymer materials, and more particularly to a reinforced polyurethane rigid foam material and a preparation method therefor.

### BACKGROUND ART

Rigid polyurethane foam plastic, polyurethane rigid foam for short, is the second most consumed type among polyurethane products after flexible polyurethane foam. Polyurethane rigid foam materials, which are mostly of a closed-cell structure, possess excellent properties such as good thermal insulation effect, light weight, high specific strength, and convenient construction, as well as characteristics such as sound insulation, shock resistance, electrical insulation, heat resistance, cold resistance, and solvent resistance, and are widely used as thermal insulation materials for the box thermal insulation layers of refrigerators and freezers, cold storage facilities, and refrigerated trucks, etc., and heat preservation materials for buildings, storage tanks, and pipelines, while a small part are applied to non-thermal-insulation scenarios such as wood-like materials and packaging materials. Generally speaking, low-density polyurethane rigid foam is mainly used as a thermal insulation (heat preservation) material, while high-density polyurethane rigid foam may be used as a structural material (wood-like material).

Ordinary polyurethane rigid foam materials possess excellent heat preservation properties, but they suffer severe shrinkage and cracking in a cryogenic environment, causing them to lose their mechanical strengths and heat preservation properties. To address this issue, they are typically compounded with continuous glass fiber mat to enhance the mechanical properties and dimensional stabilities of the polyurethane rigid foam materials at low temperatures, and certain flame retardants are added to improve the flame retardancy rating of the polyurethane. For example, US2007101441393 (publication number: CN101235128A) discloses a polyurethane foam material with a density of 400-800 kg/m³ reinforced with continuous fibers, but this material is suitable for “bearing structural materials” and cannot be used for heat preservation in an ultra-low temperature environment. US200610058849X (publication number: CN1834130A) discloses a heat preservation material with a density of 115-135 kg/m³ and a compressive strength of 1.4-1.7 MPa, but this application does not provide detailed heat conductivity coefficient for the heat preservation property of the material, and how the mechanical property of the material is at a low temperature is unknown.

Traditional continuous glass fiber mats used to enhance the strength of polyurethane foam material are usually produced in rolls, with each roll being 100-150 meters long, and can be produced only intermittently during mass production, and a considerable proportion of scrap material from the edges and corners is generated at the beginning and end of each batch, resulting in a low production efficiency and a significant environmental pollution.

Therefore, the problem urgently to be solved by those skilled in the art is how to provide an environmentally friendly reinforced polyurethane rigid foam material capable of being continuously produced.

### SUMMARY

In view of this, the present disclosure provides a reinforced polyurethane rigid foam material and a preparation method therefor.

To achieve the above purposes, the present disclosure adopts the following technical solutions.

A reinforced polyurethane rigid foam material includes the following raw materials in parts by weight: 5-10 parts of glass fiber yarn, 40-60 parts of aromatic polyether polyol, 30-50 parts of aromatic polyester polyol, 30-50 parts of toluene diisocyanate, 40-60 parts of polymethylene polyphenyl polyisocyanate, 5-10 parts of a flame retardant, 5-15 parts of a foaming agent, 1-5 parts of a catalyst, and 1-5 parts of a surfactant.

Preferably, the following raw materials in parts by weight are included: 6 parts of glass fiber yarn, 50 parts of aromatic polyether polyol, 40 parts of aromatic polyester polyol, 50 parts of toluene diisocyanate, 60 parts of polymethylene polyphenyl polyisocyanate, 5 parts of the flame retardant, 9 parts of the foaming agent, 2 parts of the catalyst, and 2 parts of the surfactant.

Further, the glass fiber yarn has a single fiber diameter of 5-15 micrometers, preferably 5-10 micrometers, and more preferably 9 micrometers; a linear density of 10-30 tex, preferably 10-15 tex, and more preferably 15 tex; and a moisture percentage of less than 0.1%, and a combustible content of 0.5%-1.5%.

The beneficial effects of adopting the above-mentioned further technical solution are that the present disclosure uses glass fiber yarn instead of the continuous glass fiber mat commonly used in traditional processes. On the one hand, the glass fiber yarn has a larger specific surface area, which may increase the effective bonding area between glass fiber and resin, and further enhance the tensile strength of the material; and on the other hand, the glass fiber mat is a roll which has a certain length limitation and can be produced only intermittently, while the glass fiber yarn may be spliced indefinitely to enable continuous production, which not only improves production efficiency but also effectively reduces the cutting loss of the head and tail parts between batches, making it more environmentally friendly.

Further, the aromatic polyether polyol has a molecular weight of 400-600, preferably 500-600, and more preferably 550; a hydroxyl value of 400-600 mg KOH/g, preferably 450-550 mg KOH/g, and more preferably 480 mg KOH/g; a viscosity of 5000-9000 mPa·S, preferably 5000-7000 mPa·S, and more preferably 6000 mPa·S; and a moisture content of less than 0.15%.

More further, the aromatic polyether polyol is at least one selected from the group consisting of toluene diamine polyether, bisphenol A polyether, and aniline-formaldehyde polyether.

The beneficial effects of adopting the above-mentioned further technical solution are that the aromatic polyether polyol of the present disclosure can introduce aromatic ring structures into the skeleton of polyurethane rigid foam, thereby enhancing the dimensional stability, heat resistance, and flame retardancy of the polyurethane rigid foam material.

Further, the aromatic polyester polyol has a molecular weight of 400-600, preferably 450-550, and more preferably 520; a hydroxyl value of 300-500 mg KOH/g, preferably 400-480, and more preferably 430; a viscosity of 4000-6000 mPa·S, preferably 4500-5500 mPa·S, and more preferably 4800 mPa·S; and a moisture content of less than 0.10%.

More further, the aromatic polyester polyol is at least one selected from the group consisting of phthalic anhydride polyester polyol, trimellitic anhydride polyester polyol, and aromatic-aliphatic copolyester.

The beneficial effects of adopting the above-mentioned further technical solution are that the aromatic polyester polyol of the present disclosure has better compatibility with the polymethylene polyphenyl polyisocyanate component, which can increase the foam fineness of the polyurethane rigid foam material, thereby improving its heat preservation property. Meanwhile, by introducing more aromatic ring structures into the skeleton of polyurethane rigid foam, the dimensional stability, heat resistance and flame retardancy of the polyurethane rigid foam material can also be increased.

Further, the polymethylene polyphenyl polyisocyanate has an isocyanate content of 25-35 wt %, preferably 25-30 wt %, and more preferably 29 wt %; a viscosity of 100-300 mPa·S, preferably 150-250 mPa S, and more preferably 200 mPa S; and a functionality of 2.5-3.5, preferably 2.0-2.5, and more preferably 2.4.

Further, the flame retardant has a phosphorus content of 5-15%, preferably 5-10%, and more preferably 9%; a viscosity of 50-200 mPa S, preferably 50-90 mPa·S, and more preferably 60 mPa·S; and a moisture content of less than 0.10%.

More further, the flame retardant is any one or a mixture of two selected from the group consisting of tris(2-chloroethyl)phosphate, tris(2-chloropropyl)phosphate, and tris(dichloropropyl)phosphate.

The beneficial effects of adopting the above-mentioned further technical solution are that the flame retardant selected in the present disclosure has low viscosity, and its addition can effectively reduce the overall viscosity of the material, and increase the fluidity of the material, thereby improving the wetting speed of the material on the glass fiber yarn, and making the distribution of the glass fiber yarn in the rigid foam more uniform.

Further, the foaming agent has a boiling point of 5-25° C., where a foaming agent with a boiling point of 10-20° C. is preferable; and a moisture content of less than 0.05%.

More further, the foaming agent is any one or a mixture of two selected from the group consisting of pentafluoropropane and trans-1-chloro-3,3,3-trifluoropropylene.

The beneficial effects of adopting the above-mentioned further technical solution are that the ozone depletion potential (ODP) values of the two foaming agents selected in the present disclosure are both 0, which can ensure the environmental friendliness of the production process.

Further, the catalyst is a mixture of a small-molecule amine catalyst and an organotin catalyst.

More further, the small-molecule amine catalyst is any one or a mixture of two selected from the group consisting of triethylenediamine, tetramethylhexanediamine, and triethylamine; and the organotin catalyst is any one or a mixture of two selected from the group consisting of stannous octoate and dibutyltin diacetate.

Further, the surfactant is a polysiloxane polymer with a viscosity of 200-600 mPa·S and a moisture content of less than 0.05%.

More further, the surfactant is any one or a mixture of two selected from the group consisting of polysiloxane-ethylene oxide AB type linear block copolymer and polysiloxane-propylene oxide ABA type linear block copolymer.

The beneficial effects of adopting the above-mentioned further technical solution are that the flame retardant, foaming agent, catalyst and surfactant of the present disclosure can effectively improve the flame retardancy, thermal insulation property, mechanical strength and dimensional stability of the polyurethane rigid foam material.

The present disclosure further provides a preparation method for the above reinforced polyurethane rigid foam material, including the following steps:
(1) randomly laying the glass fiber yarn on a conveyor belt by a scattering mechanism to form a random network of glass fiber yarn, and then weighing the raw materials in accordance with the above parts by weight;
(2) mixing aromatic polyether polyol, aromatic polyester polyol, toluene diisocyanate, polymethylene polyphenyl polyisocyanate, flame retardant, foaming agent, catalyst and surfactant to obtain a mixture;
(3) pouring the mixture onto a flattened random network structure formed by randomly laying the glass fiber yarn, and then foaming with a foaming machine to obtain a semi-finished product; and
(4) naturally curing the semi-finished product, cutting into sections, and curing again to obtain the reinforced polyurethane rigid foam material.

Further, in step (1), the yarn-scattering mechanism has a width of 0.8-2.4 m, and preferably 1.2-2.0 m, and a walking speed of 1-2 m/s, and preferably 1.4-1.8 m/s; the thickness of the random network of the glass fiber yarn is 40-180 mm, and preferably 80-120 mm; and the density of the random network of the glass fiber yarn is 0.5-5 kg/m², and preferably 2-3 kg/m².

Further, in step (2), the mixing is performed using a high-pressure mixing head, at a mixing pressure of 40-100 bar, and preferably 80 bar; a mixing temperature of 20-30° C., and preferably 23° C.; and a discharge rate of 50-100 kg/min, and preferably 70 kg/min.

The beneficial effects of adopting the above-mentioned further technical solution are that the high-pressure mixing head in the present disclosure has a large mixing pressure, which can improve the mixing effect of hydroxyl components and isocyanate components, making the cells of polyurethane rigid foam material finer and improving the heat preservation property.

Further, in step (3), kraft paper is used to isolate a continuous glass fiber mat from a chain plate; and the apparent density of the kraft paper is 80-150 g/m².

More further, in step (3), the discharge rate of the mixture is 30-120 kg/min, and preferably 50-70 kg/min; the discharge temperature is 15-35° C., and preferably 20-30° C.; and the temperature of the chain plate is 15-35° C., preferably 20-30° C.

Further, the natural curing in step (4) is performed for a time of 40-80 min; and the curing again is performed for a time of 72 h.

Further, steps (2)-(4) are carried out in a constant-temperature constant-humidity environment, where the temperature is 10-40° C. and the humidity is 70% or below.

The beneficial effects of adopting the above-mentioned further technical solution are that the polyurethane foam foaming process of the present disclosure is carried out in a temperature- and humidity-controlled environment, the material is evenly distributed, the speed of the foaming process is uniform, and the density distribution of the polyurethane foam is also more uniform.

The beneficial effects of the present disclosure are that the present disclosure adopts glass fiber yarn to replace the continuous glass fiber mat used in the traditional process. Glass fiber yarn has a larger specific surface area, which may increase the effective bonding area between glass fiber and resin, and enhance the tensile strength of the material by 20% or more. Glass fiber mat is a roll with a length limitation and can only be produced intermittently, while glass fiber yarn may be spliced indefinitely to enable continuous production, which not only improves production efficiency but also effectively reduces the cutting loss of the head and tail parts between batches, making it more environmentally friendly. Under the premise of ensuring the low-temperature mechanical strength and heat preservation property of the material, the utilization rate of glass fiber is increased by 5% or more, enabling it to be widely used in the field of cryogenic heat preservation.

### BRIEF DESCRIPTION OF DRAWINGS

The sole FIGURE is a schematic view of the process flow of the preparation method for a polyurethane rigid foam material of the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

### Example 1

### Reinforced Polyurethane Rigid Foam Material:

(1) weighing out 5 kg of glass fiber yarn, 40 kg of toluene diamine polyether, 50 kg of trimellitic anhydride polyester, 50 kg of toluene diisocyanate, 40 kg of polymethylene polyphenyl polyisocyanate, 5 kg of tris(2-chloroethyl)phosphate, 15 kg of trans-1-chloro-3,3,3-trifluoropropylene, 1 kg of tetramethylhexanediamine, and 2 kg of polysiloxane-propylene oxide ABA type linear block copolymer, where the glass fiber yarn had a diameter of 10 micrometers, a linear density of 10 tex, a moisture percentage of 0.05%, and a combustible content of 0.5%; the toluene diamine polyether had a molecular weight of 500, a hydroxyl value of 450 mg KOH/g, a viscosity of 5000 mPa·S, and a moisture content of 0.1%; the trimellitic anhydride polyester had a molecular weight of 580, a hydroxyl value of 300 mg KOH/g, a viscosity of 4000 mPa·S, and a moisture content of 0.07%; and the polymethylene polyphenyl polyisocyanate had an isocyanate content of 29 wt %, a viscosity of 250 mPa S, and a functionality of 2.3;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 1.2 m, and a walking speed of 1.4 m/s, and the random network of glass fiber yarn had a thickness of 40 mm, and a density of 2 kg/m²;
(2) in a constant-temperature constant-humidity environment of 20° C. and 60% humidity, adding the components to a high-pressure mixing head for mixing at the pressure of 80 bar, the temperature of 20° C., and the discharge rate of 50 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 20° C.; and
(4) naturally curing the semi-finished product for 40 min, then cutting into sections, and curing again for 72 h to obtain the reinforced polyurethane rigid foam material.

### Example 2

### Reinforced Polyurethane Rigid Foam Material:

(1) weighing out 7 kg of glass fiber yarn, 50 kg of bisphenol A polyether, 40 kg of phthalic anhydride polyester, 30 kg of toluene diisocyanate, 60 kg of polymethylene polyphenyl polyisocyanate, 9 kg of tris(2-chloropropyl)phosphate, 10 kg of trans-1-chloro-3,3,3-trifluoropropylene, 1 kg of triethylenediamine, 0.5 kg of tetramethylhexanediamine, and 5 kg of polysiloxane-ethylene oxide AB type linear block copolymer, where the glass fiber yarn had a diameter of 6 micrometers, a linear density of 15 tex, a moisture percentage of 0.06%, and a combustible content of 1.0%; the bisphenol A polyether had a molecular weight of 600, a hydroxyl value of 400 mg KOH/g, a viscosity of 7000 mPa S, and a moisture content of 0.08%; the phthalic anhydride polyester had a molecular weight of 450, a hydroxyl value of 500 mg KOH/g, a viscosity of 6000 mPa·S, and a moisture content of 0.06%, and the polymethylene polyphenyl polyisocyanate had an isocyanate content of 32 wt %, a viscosity of 200 mPa·S, and a functionality of 3.5;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 2.4 m, and a walking speed of 2 m/s, and the random network of glass fiber yarn had a thickness of 80 mm, and a density of 2.5 kg/m²;
(2) in a constant-temperature constant-humidity environment of 25° C. and 40% humidity, adding the components to a high-pressure mixing head for mixing at the pressure of 100 bar, the temperature of 30° C., and the discharge rate of 70 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 25° C.; and
(4) naturally curing the semi-finished product for 65 min, then cutting into sections, and curing again for 72 h to obtain the reinforced polyurethane rigid foam material.

### Example 3

### Reinforced Polyurethane Rigid Foam Material:

(1) weighing out 9 kg of glass fiber yarn, 60 kg of phthalic anhydride-formaldehyde polyether, 40 kg of phthalic anhydride polyester, 40 kg of toluene diisocyanate, 55 kg of polymethylene polyphenyl polyisocyanate, 5 kg of tris(dichloropropyl)phosphate, 5 kg of pentafluoropropane, 1 kg of trans-1-chloro-3,3,3-trifluoropropylene, 1 kg of tetramethylhexanediamine, 0.5 kg of triethylamine, 1 kg of polysiloxane-ethylene oxide AB type linear block copolymer, and 0.5 kg of polysiloxane-propylene oxide ABA type linear block copolymer, where the glass fiber yarn had a diameter of 5 micrometers, a linear density of 20 tex, a moisture percentage of 0.05%, and a combustible content of 1.2%; the phthalic anhydride-formaldehyde polyether had a molecular weight of 550, a hydroxyl value of 450 mg KOH/g, a viscosity of 5500 mPa·S, and a moisture content of 0.09%; the phthalic anhydride polyester had a molecular weight of 550, a hydroxyl value of 350 mg KOH/g, a viscosity of 4200 mPa·S, and a moisture content of 0.08%; and the polymethylene polyphenyl polyisocyanate had an isocyanate content of 33 wt %, a viscosity of 190 mPa S, and a functionality of 2.4;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 1.6 m, and a walking speed of 1.8 m/s, and the random network of glass fiber yarn had a thickness of 180 mm, and a density of 5 kg/m²;
(2) in a constant-temperature constant-humidity environment of 25° C. and 50% humidity, adding the components to a high-pressure mixing head for mixing at the pressure of 70 bar, the temperature of 28° C., and the discharge rate of 120 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 30° C.; and
(4) naturally curing the semi-finished product for 60 min, then cutting into sections, and curing again for 72 h to obtain the reinforced polyurethane rigid foam material.

### Example 4

### Reinforced Polyurethane Rigid Foam Material:

(1) weighing out 8 kg of glass fiber yarn, 55 kg of phthalic anhydride-formaldehyde polyether, 45 kg of aromatic-aliphatic copolyester, 45 kg of toluene diisocyanate, 50 kg of polymethylene polyphenyl polyisocyanate, 2 kg of tris(2-chloroethyl)phosphate, 3 kg of tris(dichloropropyl)phosphate, 1 kg of pentafluoropropane, 7 kg of trans-1-chloro-3,3,3-trifluoropropylene, 1 kg of triethylamine, and 2.5 kg of polysiloxane-ethylene oxide AB type linear block copolymer, where the glass fiber yarn had a diameter of 15 micrometers, a linear density of 30 tex, a moisture percentage of 0.03%, and a combustible content of 0.9%; the phthalic anhydride-formaldehyde polyether had a molecular weight of 600, a hydroxyl value of 400 mg KOH/g, a viscosity of 9000 mPa S, and a moisture content of 0.07%; the aromatic-aliphatic copolyester had a molecular weight of 400, a hydroxyl value of 600 mg KOH/g, a viscosity of 8000 mPa·S, and a moisture content of 0.07%; and the polymethylene polyphenyl polyisocyanate had an isocyanate content of 30 wt %, a viscosity of 220 mPa·S, and a functionality of 2.0;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 1.4 m, and a walking speed of 1.6 m/s, and the random network of glass fiber yarn had a thickness of 100 mm, and a density of 3 kg/m²;
(2) in a constant-temperature constant-humidity environment of 30° C. and 67% humidity, adding the components to a high-pressure mixing head for mixing at the pressure of 60 bar, the temperature of 25° C., and the discharge rate of 80 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 26° C.; and
(4) naturally curing the semi-finished product for 50 min, then cutting into sections, and curing again for 72 h to obtain the reinforced polyurethane rigid foam material.

### Example 5

### Reinforced Polyurethane Rigid Foam Material:

(1) weighing out 10 kg of glass fiber yarn, 45 kg of toluene diamine polyether, 50 kg of aromatic-aliphatic copolyester, 35 kg of toluene diisocyanate, 55 kg of polymethylene polyphenyl polyisocyanate, 6 kg of tris(2-chloroethyl)phosphate, 2 kg of pentafluoropropane, 7 kg of trans-1-chloro-3,3,3-trifluoropropylene, 0.5 kg of triethylenediamine, 1 kg of triethylamine, 1.5 kg of polysiloxane-ethylene oxide AB type linear block copolymer, and 0.5 kg of polysiloxane-propylene oxide ABA type linear block copolymer, where the glass fiber yarn had a diameter of 8 micrometers, a linear density of 15 tex, a moisture percentage of 0.05%, and a combustible content of 0.5%; the toluene diamine polyether had a molecular weight of 500, a hydroxyl value of 500 mg KOH/g, a viscosity of 5000 mPa S, and a moisture content of 0.08%; the aromatic-aliphatic copolyester had a molecular weight of 500, a hydroxyl value of 500 mg KOH/g, a viscosity of 5000 mPa·S, and a moisture content of 0.09%; and the polymethylene polyphenyl polyisocyanate had an isocyanate content of 25 wt %, a viscosity of 160 mPa S, and a functionality of 2.5;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 1.2 m, and a walking speed of 1.4 m/s, and the random network of glass fiber yarn had a thickness of 80 mm, and a density of 2.6 kg/m²;
(2) in a constant-temperature constant-humidity environment of 25° C. and 35% humidity, adding the components to a high-pressure mixing head for mixing at the pressure of 80 bar, the temperature of 28° C., and the discharge rate of 75 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 28° C.; and
(4) naturally curing the semi-finished product for 45 min, then cutting into sections, and curing again for 72 h to obtain the reinforced polyurethane rigid foam material.

### Example 6

### Reinforced Polyurethane Rigid Foam Material:

(1) weighing out 7 kg of glass fiber yarn, 45 kg of toluene diamine polyether, 55 kg of phthalic anhydride polyester, 45 kg of toluene diisocyanate, 60 kg of polymethylene polyphenyl polyisocyanate, 10 kg of tris(2-chloropropyl)phosphate, 8 kg of pentafluoropropane, 1 kg of triethylenediamine, 1 kg of triethylamine, 1 kg of polysiloxane-ethylene oxide AB type linear block copolymer, and 1.5 kg of polysiloxane-propylene oxide ABA type linear block copolymer, where the glass fiber yarn had a diameter of 6 micrometers, a linear density of 20 tex, a moisture percentage of 0.06%, and a combustible content of 0.8%; the toluene diamine polyether had a molecular weight of 500, a hydroxyl value of 550 mg KOH/g, a viscosity of 6500 mPa·S, and a moisture content of 0.08%; the phthalic anhydride polyester had a molecular weight of 500, a hydroxyl value of 550 mg KOH/g, a viscosity of 6000 mPa·S, and a moisture content of 0.09%; and the polymethylene polyphenyl polyisocyanate had an isocyanate content of 27 wt %, a viscosity of 210 mPa·S, and a functionality of 2.6;
where multiple sets of glass fiber yarn bobbins constituted a glass fiber yarn matrix, and the glass fiber yarn was randomly laid by the yarn-scattering mechanism to form a random network structure of glass fiber yarn with a certain thickness and density, and then entered the foaming area through the chain plate; and the yarn-scattering mechanism had a width of 0.8 m, and a walking speed of 1 m/s, and the random network of glass fiber yarn had a thickness of 60 mm, and a density of 0.5 kg/m²;
(2) in a constant-temperature constant-humidity environment of 25° C. and 35% humidity, adding the components to a high-pressure mixing head for mixing at the pressure of 40 bar, the temperature of 28° C., and the discharge rate of 30 kg/min to obtain a mixture;
(3) evenly spreading the mixture on the random network structure of glass fiber yarn through the feeding material pipe, wetting the entire network structure, and then beginning to react and foam to form a semi-finished product material of reinforced polyurethane rigid foam, where the temperature of the chain plate was 15° C.; and
(4) naturally curing the semi-finished product for 45 min, then cutting into sections, and curing again for 72 h to obtain the reinforced polyurethane rigid foam material.

### Comparative Example 1

Reinforced polyurethane rigid foam material:
(1) weighing out 9 kg of continuous glass fiber mat, 60 kg of toluene diamine polyether, 40 kg of trimellitic anhydride polyester, 40 kg of toluene diisocyanate, 55 kg of polymethylene polyphenyl polyisocyanate, 5 kg of tris(2-chloropropyl)phosphate, 4 kg of pentafluoropropane, 2 kg of trans-1-chloro-3,3,3-trifluoropropylene, 1.5 kg of triethylamine, and 1.5 kg of polysiloxane-ethylene oxide AB type linear block copolymer, where the continuous glass fiber mat had a density of 1 kg/m², the toluene diamine polyether had a molecular weight of 550, a hydroxyl value of 500 mg KOH/g, a viscosity of 7500 mPa·S, and a moisture content was 0.1%; the phthalic anhydride polyester had a molecular weight of 500, a hydroxyl value of 550 mg KOH/g, a viscosity of 6000 mPa·S, and a moisture content of 0.09%; and the polymethylene polyphenyl polyisocyanate had an isocyanate content of 31 wt %, a viscosity of 230 mPa·S, and a functionality of 2.9;
adding the components to a high-pressure mixing head for mixing at the pressure of 70 bar, the temperature of 28° C., and the discharge rate of 120 kg/min to obtain a mixture;
(2) in a constant-temperature constant-humidity environment of 25° C. and 50% humidity, pouring the mixture onto a flattened continuous glass fiber mat, and then performing foaming and shaping to obtain a semi-finished product, where the chain plate temperature was 30° C.; and
(3) naturally curing the semi-finished product for 45 min, then cutting into sections, and curing again for 72 h to obtain the reinforced polyurethane rigid foam material.

### Comparative Example 2

Reinforced polyurethane rigid foam material:
(1) weighing 10 kg of continuous glass fiber mat, 45 kg of aniline-formaldehyde polyether, 50 kg of aromatic-aliphatic copolyester, 35 kg of toluene diisocyanate, 55 kg of polymethylene polyphenyl polyisocyanate, 6 kg of tris(2-chloropropyl)phosphate, 3 parts of pentafluoropropane, 6 parts of trans-1-chloro-3,3,3-trifluoropropylene, 1 part of tetramethylhexanediamine, 2 parts of polysiloxane-ethylene oxide AB type linear block copolymer, and 1.5 parts of polysiloxane-propylene oxide ABA type linear block copolymer, where the continuous glass fiber mat had a density of 0.5 kg/m², the aniline-formaldehyde polyether had a molecular weight of 580, a hydroxyl value of 480 mg KOH/g, a viscosity of 5800 mPa·S, a moisture content of 0.1%; the phthalic anhydride polyester had a molecular weight of 480, a hydroxyl value of 480 mg KOH/g, a viscosity of 4800 mPa·S, and a moisture content of 0.1%; and the polymethylene polyphenyl polyisocyanate had an isocyanate content of 30 wt %, a viscosity of 220 mPa·S, and a functionality of 2.8;
adding the components to a high-pressure mixing head for mixing at the pressure of 80 bar, the temperature of 28° C., and the discharge rate of 75 kg/min to obtain a mixture;
(2) in a constant-temperature constant-humidity environment of 25° C. and 35% humidity, pouring the mixture onto a flattened continuous glass fiber mat, and then performing foaming and shaping to obtain a semi-finished product, where the chain plate temperature was 28° C.; and
(3) naturally curing the semi-finished product for 45 min, then cutting into sections, and curing again for 72 h to obtain the reinforced polyurethane rigid foam material.

### Performance Testing

The polyurethane rigid foam materials prepared in Examples 1-6 and Comparative Examples 1-2 were tested for their density, compressive strength, tensile strength, thermal conductivity, closed-cell ratio, surface flatness and core material utilization rate. The test results are as shown in Table 1.

In the above, the performance evaluation methods were as follows.

Density: the polyurethane rigid foam material was stripped of its outer skin and cut into cubes, and tested in accordance with GB/T 6343-2009.

Compressive strength: the polyurethane rigid foam material was cut into samples of 50 mm×50 mm×50 mm and tested under the condition of −160° C. in accordance with GB/T 8813-2008.

Tensile strength: the polyurethane rigid foam material was cut into dumbbell-shaped samples and tested under the condition of −160° C. in accordance with BS ISO 1926-2005.

Thermal conductivity: the polyurethane rigid foam material was cut into samples of 300 mm×300 mm×30 mm and tested under the condition of −160° C. in accordance with ISO 8302. Closed-cell ratio: the polyurethane rigid foam material was cut into samples of 30 mm×30 mm×50 mm and tested under the condition of 20° C. in accordance with GB/T 10799-1989.

Surface flatness: it was calculated by measuring the difference between the lowest point and highest point of the surface of the polyurethane rigid foam material.

Core material utilization rate: it was obtained by calculating the ratio of the volume of the polyurethane rigid foam material with the top, bottom and side skins removed to the volume of the polyurethane rigid foam material blank.

TABLE 1
Performance Testing Results of Polyurethane Rigid Foam
Materials in Examples 1-6 and Comparative Examples 1-2

| | | | | | | | Comparative | Comparative |
|---|---|---|---|---|---|---|---|---|
| Item | Example 1 | Example 2 | Example 3 | Example 4 | Example 5 | Example 6 | Example 1 | Example 2 |
| Density | 120 | 150 | 120 | 130 | 120 | 120 | 120 | 120 |
| (kg/m³) | | | | | | | | |
| Compressive | 1.4 | 1.7 | 1.4 | 1.4 | 1.4 | 1.5 | 1.2 | 1.2 |
| Strength | | | | | | | | |
| (MPa) | | | | | | | | |
| Tensile | 3.2 | 3.5 | 3.8 | 3.5 | 3.7 | 3.6 | 2.9 | 2.8 |
| Strength | | | | | | | | |
| (MPa) | | | | | | | | |
| Thermal | 23 | 24 | 26 | 24 | 24 | 24 | 25 | 25 |
| Conductivity | | | | | | | | |
| (mw/m · k) | | | | | | | | |
| @20° C. | | | | | | | | |
| Glass | 95 | 96 | 95 | 95 | 94 | 94 | 87 | 88 |
| Fiber | | | | | | | | |
| Utilization | | | | | | | | |
| Rate (%) | | | | | | | | |

As shown in Table 1, compared with Comparative Examples 1-2, the polyurethane rigid foam materials prepared in Examples 1-7 of the present disclosure have significantly improved properties such as density, compressive strength, tensile strength, thermal conductivity, and glass fiber utilization rate.

The above results show that the density of the polyurethane rigid foam material of the present disclosure is 80-150 kg/m³, the uninterrupted production of reinforced polyurethane rigid foam material can be realized, the tensile performance of the material is improved by 20% or more, the glass fiber utilization rate is increased by 5% or more, and it can be widely used in the field of liquefied gas storage and transportation.

Although embodiments of the present disclosure have been shown and described above, it is understood that the above embodiments are exemplary and should not be construed as limiting the present disclosure. Those ordinarily skilled in the art can make changes, modifications, substitutions and variations to the above embodiments within the scope of the present disclosure.

1. A reinforced polyurethane rigid foam material, comprising following raw materials in parts by weight: 5-10 parts of glass fiber yarn, 40-60 parts of aromatic polyether polyol, 30-50 parts of aromatic polyester polyol, 30-50 parts of toluene diisocyanate, 40-60 parts of polymethylene polyphenyl polyisocyanate, 5-10 parts of a flame retardant, 5-15 parts of a foaming agent, 1-5 parts of a catalyst, and 1-5 parts of a surfactant,
wherein the aromatic polyether polyol has a molecular weight of 400-600, a hydroxyl value of 400-600 mg KOH/g, and a viscosity of 5000-9000 mPa·S; the aromatic polyester polyol has a molecular weight of 400-600, a hydroxyl value of 300-500 mg KOH/g, and a viscosity of 4000-6000 mPa·S; the aromatic polyether polyol is at least one selected from the group consisting of toluene diamine polyether, bisphenol A polyether, and aniline-formaldehyde polyether; and the aromatic polyester polyol is at least one selected from the group consisting of phthalic anhydride polyester polyol and trimellitic anhydride polyester polyol;
the catalyst is a mixture of a small-molecule amine catalyst and an organotin catalyst; the small-molecule amine catalyst is any one or a mixture of two selected from the group consisting of triethylenediamine, tetramethylhexanediamine, and triethylamine; and the organotin catalyst is any one or a mixture of two selected from the group consisting of stannous octoate and dibutyltin diacetate;
the flame retardant is any one or a mixture of two selected from the group consisting of tris(2-chloroethyl)phosphate, tris(2-chloropropyl)phosphate, and tris(dichloropropyl)phosphate, and the foaming agent is any one or a mixture of two selected from the group consisting of pentafluoropropane and trans-1-chloro-3,3,3-trifluoropropylene; and
the surfactant is a polysiloxane polymer with a viscosity of 200-600 mPa's and a moisture content of less than 0.05%, and the surfactant is any one or a mixture of two selected from the group consisting of polysiloxane-ethylene oxide AB type linear block copolymer and polysiloxane-propylene oxide ABA type linear block copolymer.

2. The reinforced polyurethane rigid foam material according to claim 1, wherein the glass fiber yarn has a single fiber diameter of 5-15 μm, a linear density of 10-30 tex, a moisture percentage of less than 0.1%, and a combustible content of 0.5%-1.5%.

3-5. (canceled)

6. A preparation method for the reinforced polyurethane rigid foam material according to claim 1, comprising the following steps:
(1) randomly laying a glass fiber yarn on a conveyor belt by a scattering mechanism to form a random network of the glass fiber yarn, and then weighing raw materials in parts by weight;
(2) mixing aromatic polyether polyol, aromatic polyester polyol, toluene diisocyanate, polymethylene polyphenyl polyisocyanate, the flame retardant, the foaming agent, the catalyst and the surfactant to obtain a mixture;
(3) pouring the mixture onto a flattened random network structure formed by random laying of glass fiber yarn, and then foaming with a foaming machine to obtain a semi-finished product, wherein kraft paper is used to isolate a continuous glass fiber mat from a chain plate, and an apparent density of the kraft paper is 80-150 g/m²; and
(4) naturally curing the semi-finished product, then cutting into sections, and curing again to obtain the reinforced polyurethane rigid foam material,
wherein steps (2)-(4) are carried out in a constant-temperature constant-humidity environment, wherein a temperature is 10-40° C. and a humidity is 70% or below.

7. The preparation method for the reinforced polyurethane rigid foam material according to claim 6, wherein in step (2), the mixing is performed using a high-pressure mixing head, at a pressure of 40-100 bar, a temperature of 5-25° C., and a discharge rate of 40-160 kg/min.

8. (canceled)

9. The preparation method for the reinforced polyurethane rigid foam material according to claim 6, wherein the natural curing in step (4) is performed for a time of 40-80 min; and the curing again is performed for a time of 72 h.

10. (canceled)

11. The preparation method for the reinforced polyurethane rigid foam material according to claim 6, wherein the glass fiber yarn has a single fiber diameter of 5-15 μm, a linear density of 10-30 tex, a moisture percentage of less than 0.1%, and a combustible content of 0.5%-1.5%.
